(19) United States
(12) Patent Application Publication
(10) Pub. No.: US 2007/0059535 A1
(43) Pub. Date: Mar. 15, 2007

(54) Silicone-based pressure-sensitive adhesive and adhesive tape

(76) Inventor: Akihiro Nakamura, Chiba Prefecture (JP)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/560,370

(22) PCT Filed: Jun. 11, 2004
(86) PCT No.: PCT/JP04/08588

§ 371 Date: Dec. 13, 2005

(30) Foreign Application Priority Data
Jun. 13, 2003 (JP) 2003-169533
Apr. 16, 2004 (JP) 2004-121005

(51) Int. Cl. B32B 9/04; C08L 83/04; C08K 5/18

(52) U.S. Cl. 428/447; 525/477; 525/478; 528/15; 528/31; 528/32; 524/236

(57) ABSTRACT

A silicone-based pressure-sensitive adhesive comprises (A) a partial condensation product or a mixture of (a) a crude rubber-like organopolysiloxane having an average of at least one alkenyl group per molecule, and (b) an organopolysiloxane resin consisting essentially of R [symbol] 1??3#191SiO?1/2#191 units and SiO?4/2#191 units; (B) an organopolysiloxane having an average of at least two silicon-bonded hydrogen atoms per molecule; (C) an aromatic amine compound, and/or an organopolysiloxane that contains aromatic amino groups; and (D) a platinum catalyst. The pressure-sensitive adhesive forms a pressure-sensitive adhesive layer that is easily repeelable after being exposed to a high temperatures.

### TECHNICAL FIELD

This invention relates to a silicone-based pressure-sensitive adhesive and an adhesive tape, and more specifically, to a silicone-based pressure-sensitive adhesive for forming a pressure-sensitive adhesive layer that is repeelable after being exposed to a high temperature. The invention also relates to the adhesive tape that is repeelable after being exposed to a high temperature.

### BACKGROUND ART

Silicone-based pressure-sensitive adhesives possess excellent electric insulation, heat resistance, and adhesive properties, and are used in applications that require reliability. Depending on the mechanism of curing, silicone-based pressure-sensitive adhesives can be divided into addition reaction-curable types, condensation reaction-curable types, and curable types with peroxides. Addition reaction-curable types are most preferred since they can be cured at room temperature or accompanied by heat when it is required to accelerate the curing.

Japanese Patent Publication No. Sho 54-37907, corresponding to U.S. Pat. No. 3,983,298 (Sep. 28, 1976), discloses an addition reaction-curable silicone-based pressure-sensitive adhesive comprising (a) an organopolysiloxane resin containing R₃SiO_{1/2} units wherein R is a univalent hydrocarbon group with 6 or less carbon atoms, and SiO_{4/2} units; (b) a diorganopolysiloxane having vinyl groups bonded to silicon atoms on both molecular terminals; (c) an organopolysiloxane having silicon-bonded hydrogen atoms, in an amount that silicon-bonded hydrogen atoms in component (c) is within the range of 1.0 to 20.0 moles per 1 mole of total alkenyl groups in components (a) and (b); and (d) a platinum catalyst.

Another example of a silicone-based pressure-sensitive adhesive is shown in Japanese Patent Application Laid-Open No. Sho 63-22886, corresponding to U.S. Pat. No. 4,774,297 (Sep. 27, 1988). It consists of (A) a diorganopolysiloxane having alkenyl groups bonded to silicon atoms on both molecular terminals; (B) organopolysiloxane resin containing R₃SiO_{1/2} units wherein R is an alkyl group, an alkenyl group, or a hydroxyl group, and SiO_{4/2} units; (C) an organopolysiloxane having at least two silicon-bonded hydrogen atoms per molecule, in an amount that silicon-bonded hydrogen atoms in component (C) is within the range of 1.0 to 20.0 moles per 1 mole of alkenyl groups in component (A); (D) a platinum catalyst; and (E) an organic solvent.

Lastly, Japanese Patent Publication No. Hei 5-34391, corresponding to U.S. Pat. No. 5,216,069 (Jun. 1, 1993), discloses another example of a silicone-based pressure-sensitive adhesive consisting of (i) an organopolysiloxane that is the product of a partial condensation of a diorganopolysiloxane having hydroxyl groups bonded to silicon atoms on both molecular terminals and containing alkenyl groups, and an organopolysiloxane that contains R₃SiO_{1/2} units wherein R is a univalent hydrocarbon group having 3 or less carbon atoms, and SiO_{4/2} units; (ii) an organopolysiloxane having silicon-bonded hydrogen atoms, in an amount that a mole ratio of silicon-bonded hydrogen atoms of component (ii) to the alkenyl groups contained in (i) is within the range of 1 to 30; and (iii) a platinum catalyst.

However, known silicone-based pressure-sensitive adhesives have some disadvantages. In particular, when an adhesive tape is attached to a surface of an object with such adhesives and exposed to a high temperature over a long period of time, peeling of the tape from the surface of the object to which it is attached leaves an adhesive residue on the surface. For example, when heat treatment masking tape is used in a solder reflow step during treatment of a printed circuit board (PCB), peeling of the tape from the PCB after completion of the operation leaves some residual material of the pressure-sensitive adhesive layer on the PCB surface. The residual material serves as a source of problems in subsequent operations.

It is an object of the present invention therefore to provide a silicone-based pressure-sensitive adhesive for forming a pressure-sensitive adhesive layer that is repeelable after being exposed to high temperatures. It is another object of the invention to provide an adhesive tape that is repeelable after being exposed to high temperatures.

The silicone-based pressure-sensitive adhesive of the invention is efficient in that it can form pressure-sensitive adhesive layers that are repeelable after being exposed to high temperatures. Similarly, the adhesive tape is efficient in that it can be repeeled after being exposed to high temperatures.

### DISCLOSURE OF INVENTION

Silicone-based pressure-sensitive adhesives according to the invention comprise:

(A) a product of partial condensation or a mixture of constituents (a) and (b), where constituent (a) is a crude rubber-like organopolysiloxane having an average of at least one alkenyl group per molecule, and constituent (b) is an organopolysiloxane resin consisting essentially of R¹₃SiO_{1/2} units where R¹ is a substituted or unsubstituted univalent hydrocarbon group, and SiO_{4/2} units, wherein the mole ratio of R¹₃SiO_{1/2} units to SiO_{4/2} units is within the range of 0.5 to 1.5;

(B) an organopolysiloxane having an average of at least two silicon-bonded hydrogen atoms per molecule, where the silicon-bonded hydrogen atoms are present in an amount of 0.5 to 150.0 moles per 1 mole of the alkenyl groups in component (A);

(C) an aromatic amine compound and/or an organopolysiloxane that contains aromatic amino groups, in an amount of 0.001 to 10 parts by weight per 100 parts by weight of component (A); and

(D) a platinum catalyst in an amount sufficient to provide curing of the adhesives.

Adhesive tapes according to the invention comprise a support film and a pressure-sensitive adhesive layer in which the adhesive layer is formed by curing the above-mentioned silicone-based pressure-sensitive adhesive.

### DETAILED DESCRIPTION OF THE INVENTION

Constituent (a) is an organopolysiloxane containing an average of at least one alkenyl group per molecule. If the average amount of alkenyl groups per molecule is less than 1, the resulting pressure-sensitive adhesive will have a reduced cohesive or holding power. Constituent (a) is crude rubber-like and its plasticity is preferably within the range of 50 to 200, even more preferably 80 to 180. Plasticity is measured in accordance with Japanese Industrial Standard (JIS) K 6249 at 25° C., by applying a 1 kg force for 3 minutes to a spherical sample material weighing 4.2 gram. While there are no special limitations with regard to the molecular structure of constituent (a), a linear structure is preferable, but it can be partially branched.

The alkenyl groups in constituent (a) can be vinyl groups, allyl groups, butenyl groups, or pentenyl groups, however vinyl groups are preferred. Constituent (a) may contain groups other than alkenyl groups bonded to the silicon atoms. These other groups can be substituted or unsubstituted univalent hydrocarbon groups such as methyl groups, ethyl groups, propyl groups, butyl groups, pentyl groups, heptyl groups, octyl groups, and similar linear chain alkyl groups; isopropyl groups, sec-butyl groups, tert-butyl groups, isopentyl groups, tert-pentyl groups, neopentyl groups, tert-octyl groups, and similar branched chain alkyl groups; phenyl groups, tolyl groups, xylyl groups, and similar aryl groups; benzyl groups, phenethyl groups, or similar aralkyl groups; chloromethyl groups, 3-chloropropyl groups, 3,3,3-trifluoropropyl groups, and similar halogenated alkyl groups. Most preferable of the above other groups are methyl groups and phenyl groups.

When constituent (a) is subjected to partial condensation with one of the below described constituents (b), it is preferred that constituent (a) contain at least 0.01 weight percent of silicon-bonded hydroxyl groups or silicon-bonded hydrolysable groups. Such hydrolysable groups may be exemplified by methoxy groups, ethoxy groups, propoxy groups, and similar alkoxy groups; acetoxy groups; isopropenoxy groups; and aminoxy groups.

Constituent (b) is an organopolysiloxane resin that consists essentially of R₁₃SiO_{1/2} units and SiO_{4/2} units. R¹ can be a substituted or an unsubstituted univalent hydrocarbon group. Some groups representative of R¹ include methyl groups, ethyl groups, propyl groups, butyl groups, pentyl groups, heptyl groups, octyl groups, and similar linear chain alkyl groups; isopropyl groups, sec-butyl groups, tert-butyl groups, isopentyl groups, tert-pentyl groups, neopentyl groups, tert-octyl groups, and similar branched chain alkyl groups; vinyl groups, allyl groups, butenyl groups, pentenyl groups, and similar alkenyl groups; phenyl groups, tolyl groups, xylyl groups, and similar aryl groups; benzyl groups, phenethyl groups, and similar aralkyl groups; chloromethyl groups, 3-chloropropyl groups, 3,3,3-trifluoropropyl groups, and similar halogenated alkyl groups. Most preferred are methyl, vinyl, and phenyl groups.

When constituent (b) is subjected to partial condensation with constituent (a), it is preferred that constituent (b) contain at least 0.01 weight percent of silicon-bonded hydroxyl groups or silicon-bonded hydrolysable groups. Such hydrolysable groups may be exemplified by methoxy groups, ethoxy groups, propoxy groups, and similar alkoxy groups; acetoxy groups; isopropenoxy groups; and aminoxy groups.

While constituent (b) should consist essentially of R¹₃SiO_{1/2} units and SiO_{4/2} units, it may also contain R¹₂SiO_{2/2} units and R¹SiO_{3/2} units. It is preferable that the total amount of R¹₃SiO_{1/2} units and SiO_{4/2} units in constituent (b) exceed 50 weight percent, preferably 80 weight percent, and more preferably 100 weight percent. However, it is most preferred that constituent (b) consist of only R¹₃SiO_{1/2} units and SiO_{4/2} units. The mole ratio of R¹₃SiO_{1/2} units to SiO_{4/2} units should be within the range of 0.5 to 1.5, preferably 0.5 to 1.0, and even more preferably 0.6 to 0.9. If the ratio is below the lower limit, the obtained pressure-sensitive adhesive will tend to decrease in tackiness. If the ratio exceeds the upper limit, the pressure-sensitive adhesive will loose its adhesive strength.

As noted above, component (A) may comprise a mixture of constituents (a) and (b), or a product of partial condensation of constituents (a) and (b). It is preferred that component (A) have a weight ratio of constituents (a) and (b) in the range of 1:9 to 9:1, preferably 2:8 to 8:2, and even more preferably 3:7 to 7:3. The partial condensation reaction of constituents (a) and (b) can be carried out by heating the two constituents. The partial condensation reaction can be also be carried out in the presence of a catalyst such as potassium hydroxide, barium hydroxide or similar bases; ammonia water; methylamine, ethylamine, propylamine, or similar amines; tetrabutyl titanate, tetraisobutyl titanate, or similar titanium compounds; octyltin diacetate and similar tin compounds; and hexamethyldisilazane.

Component (B) is the crosslinking agent and is an organopolysiloxane that has an average of at least two silicon-bonded hydrogen atoms per molecule. In component (B), the silicon-bonding positions of the hydrogen atom may be on the molecular terminals and/or on side molecular chains. Silicon-bonded groups in component (B) may be groups other than hydrogen such as methyl groups, ethyl groups, propyl groups, butyl groups, pentyl groups, heptyl groups, octyl groups, and similar linear chain alkyl groups; isopropyl groups, sec-butyl groups, tert-butyl groups, isopentyl groups, tert-pentyl groups, neopentyl groups, tert-octyl groups, and similar branched chain alkyl groups; phenyl groups, tolyl groups, xylyl groups, naphthyl groups, and similar aryl groups; benzyl groups, phenethyl groups, and similar aralkyl groups; chloromethyl groups, 3-chloropropyl groups, 3,3,3-trifluoropropyl groups, and similar halogenated alkyl groups; as well as other substituted or unsubstituted univalent hydrocarbon groups except for alkenyl groups. Most preferred are methyl and phenyl groups. Component (B) may have a linear, branched, cyclic, or partially branched molecular structure. A linear molecular structure is preferred however. While there are no special restrictions with regard to the viscosity of component (B), it is preferred that the viscosity of this component be within the range of 0.1 to 500,000 mPa·s, preferably 1 to 100,000 mPa·s at 25° C.

The organopolysiloxane component (B) is represented polymers and copolymers such as a methylhydrogenpolysiloxane having both of its molecular terminals end capped with trimethylsiloxy groups; a copolymer of methylhydrogensiloxane and dimethylsiloxane having both of its molecular terminals end capped with trimethylsiloxy groups; a copolymer of dimethylsiloxane, methylhydrogensiloxane, and methylphenylsiloxane, having both of its molecular terminals end capped with trimethylsiloxy groups; a dimethylpolysiloxane having both of its molecular terminals end capped with dimethylhydrogensiloxy groups; a copolymer of methylphenylpolysiloxane and dimethylsiloxane having both of its molecular terminals end capped with dimethylhydrogensiloxy groups; a methylphenylpolysiloxane having both of its molecular terminals end capped with dimethylhydrogensiloxy groups; an organopolysiloxane resin containing siloxane units of the formulae R⁶₃SiO_{1/2}, R⁶₂HSiO_{1/2}, and SiO_{4/2}; an organopolysiloxane resin containing siloxane units of the formulae R⁶₂HSiO_{1/2}, and SiO_{4/2}; an organopolysiloxane resin containing siloxane units of the formulae R⁶HSiO_{2/2}, R⁶SiO_{3/2} and HSiO_{3/2}; and mixture of two or more of such organopolysiloxanes. R⁶ represents substituted or unsubstituted univalent hydrocarbon groups other than alkenyl groups.

Component (B) should be used in an amount such that the silicon-bonded hydrogen atoms present in the component is in the range of 0.5 to 150.0 moles, preferably 0.6 to 150.0 moles, more preferably 0.7 to 140.0 moles, and even more preferably 0.8 to 130.0 moles, per 1 mole of alkenyl groups in component (A). If the content of silicon-bonded hydrogen atoms in (B) is below the lower limit, it is difficult to provide sufficient curing of the resulting pressure-sensitive adhesive, and it will have a reduced cohesive and/or holding capacity. If the content of silicon-bonded hydrogen atoms in (B) exceeds the preferred upper limit, the resulting pressure-sensitive adhesive will impart to an adhesive paper or tape an increased resistance to peeling. With the lapse of time, the resistance to peeling will increase.

Component (C) is the constituent used for improving repeelability of the adhesive tape after its exposure to high temperature. This component can be an aromatic amine compound and/or an organopolysiloxane that contains aromatic amino groups. While there are no special restrictions with regard to the aromatic amine compounds of (C), it is preferred to use compounds of the following general formula:

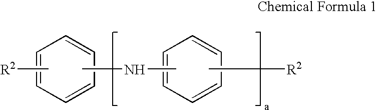

In Chemical Formula 1, R² can be the same or different, and can be H, OH, or a univalent hydrocarbon group. Preferably, R² is H or a univalent hydrocarbon group. Some examples of R² are univalent hydrocarbon groups that are the same the substituted or unsubstituted univalent hydrocarbon groups defined above for R¹. Preferably, these groups are linear or branched chain alkyl groups. In Chemical Formula 1, a represents an integer equal to or exceeding one.

Below are some specific examples of aromatic amine compounds of component (C) or derivatives of such compounds, in which a part of the hydrogen atoms in the aromatic rings is substituted by methyl groups, ethyl groups, propyl groups, butyl groups, pentyl groups, heptyl groups, octyl groups, and similar linear chain alkyl groups; isopropyl groups, sec-butyl groups, tert-butyl groups, isopentyl groups, tert-pentyl groups, neopentyl groups, tert-octyl groups, and similar branched chain alkyl groups.

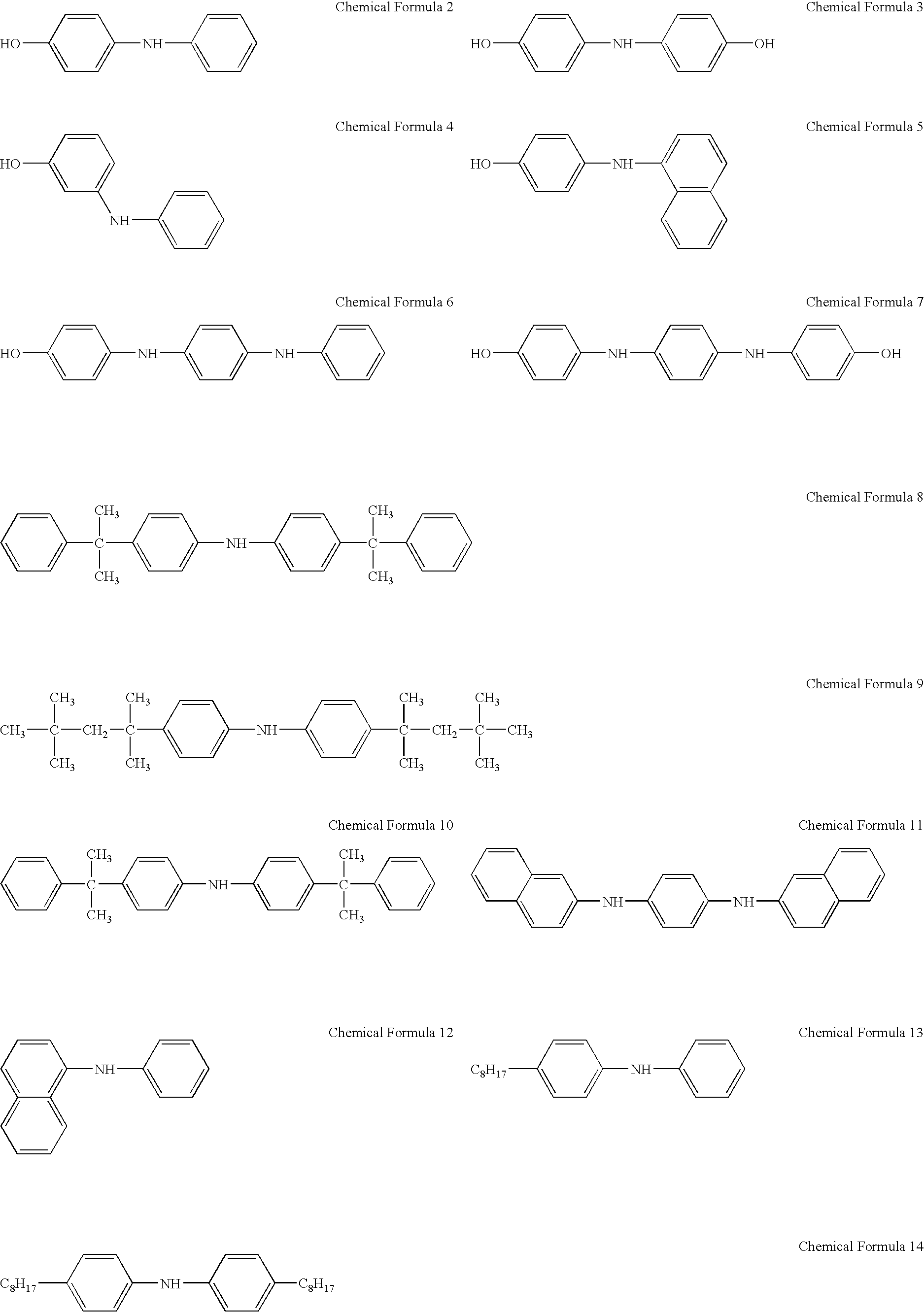

While there are no special restrictions with regard component (C), the organopolysiloxane containing aromatic amino groups should have at least one silicon-bonded aromatic amino group per molecule. In this regard, there are no special restrictions on the bonding position of the aromatic amino group. Thus, the group can be bonded to a molecular chain terminal and/or to a side molecular chain. In addition, there are no restriction with regard to the molecular structure of the organopolysiloxane, and it can have a linear, cyclic, branched, or partially branched molecular structure. The organopolysiloxane (C) containing aromatic amino groups may be represented by the formula:

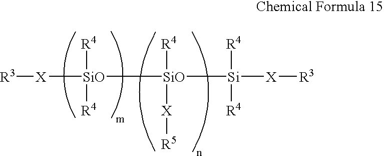

In Formula 15, R³ can be a substituted or unsubstituted univalent hydrocarbon group or an aromatic amino group. When R³ is a hydrocarbon group, some examples of substituted or unsubstituted univalent hydrocarbon groups are linear chain alkyl groups including methyl groups, ethyl groups, propyl groups, butyl groups, pentyl groups, heptyl groups, and octyl groups; branched chain alkyl groups such as the isopropyl groups, sec-butyl groups, tert-butyl groups, isopentyl groups, tert-pentyl groups, neopentyl groups, and tert-octyl groups; alkenyl groups such as the vinyl groups, allyl groups, butenyl groups, and pentenyl groups; aryl groups such as the phenyl groups, tolyl groups, xylyl groups, and naphthyl groups; aralkyl groups such as the benzyl groups and phenethyl groups; halogenated alkyl groups such as the chloromethyl groups, 3-chloropropyl groups, and the 3,3,3-trifluoropropyl groups.

When R³ is an aromatic amino group, it can be exemplified by unsubstituted groups shown below, or by the same groups in which a part of hydrogen atoms in the aromatic rings are substituted with alkyl groups such as linear chain alkyl groups including methyl groups, ethyl groups, propyl groups, butyl groups, pentyl groups, heptyl groups, and octyl groups; and branched chain alkyl groups such as isopropyl groups, sec-butyl groups, tert-butyl groups, isopentyl groups, tert-pentyl groups, neopentyl groups, and tert-octyl groups.

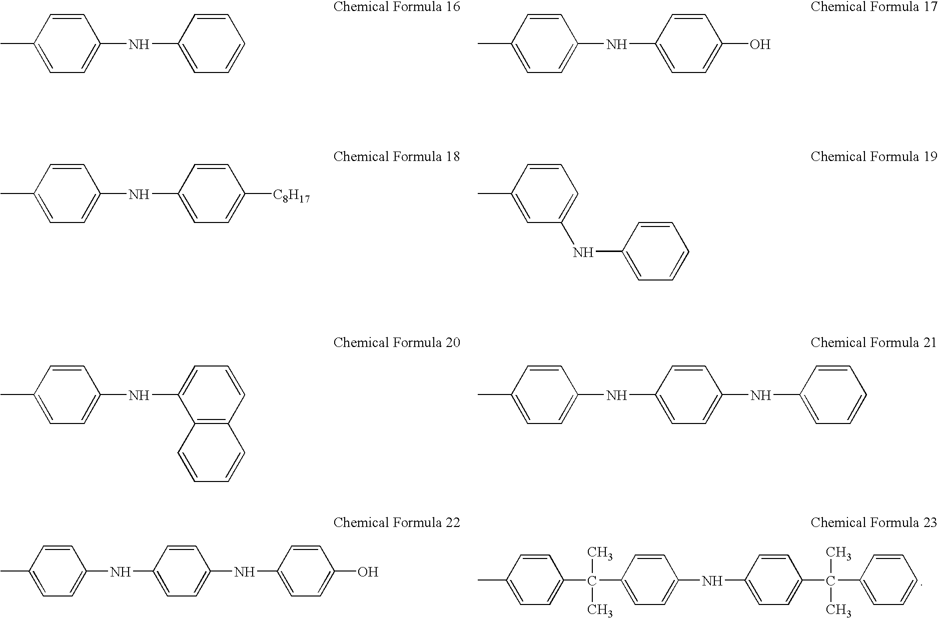

R³ is preferred an aromatic amino group, in which a part of the hydrogen atomes in the aromatic rings is not substituted by hydroxy groups.

R⁴ in Formula 15 designates a substituted or unsubstituted univalent hydrocarbon groups that may be the same as the univalent hydrocarbon groups named for R³. Of these groups, methyl and phenyl groups are most preferred.

In Formula 15, R⁵ designates an aromatic amino group which is the same as the aromatic amino groups defined previously for R².

X in Formula 15 designates a single bond, an oxygen atom, an alkylene group, or an alkyleneoxy group. Some examples of alkylene groups that may represent X are methylene groups, ethylene groups, and propylene groups. Some examples of alkyleneoxy groups that may represent X are methyleneoxy groups, ethyleneoxy groups, and propylenoxy groups.

In Formula 15, m is a positive number within the range of 1 to 3,000, and n can be zero or a positive number. In addition, in Formula 15, at least one of the R³ groups is an aromatic amino group.

The following formulae are some examples of organopolysiloxanes containing aromatic amino groups in which m and p are positive numbers.

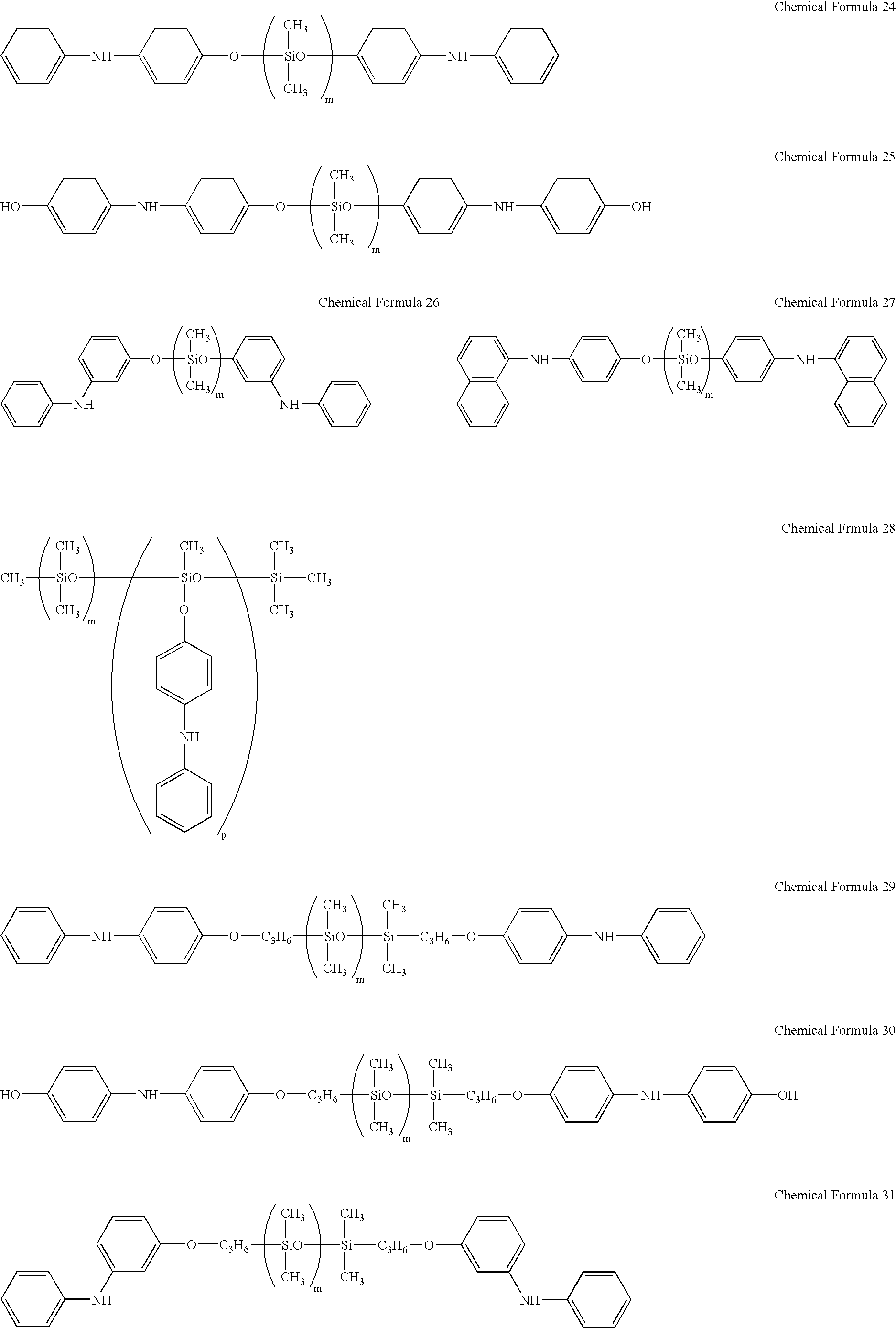

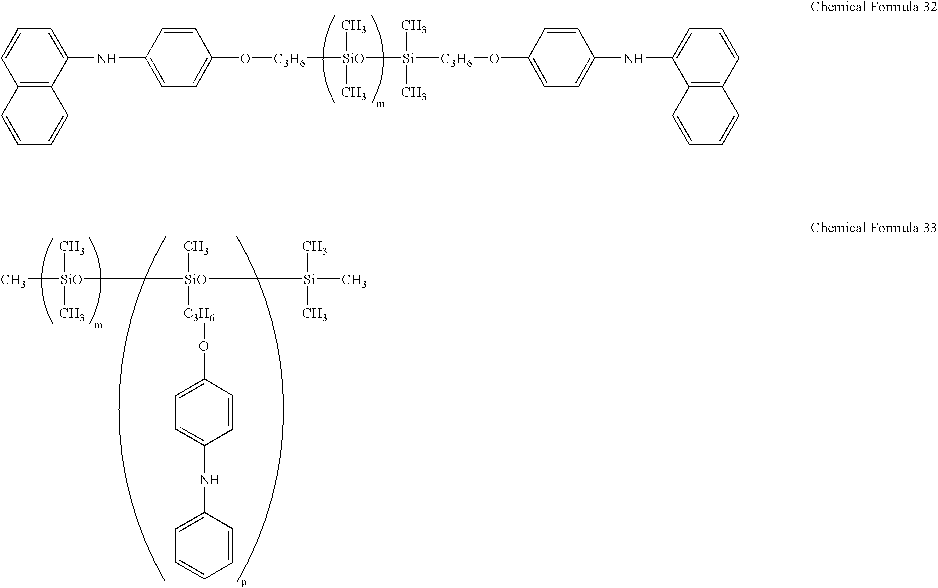

These aromatic amino group-containing organopolysiloxanes can be prepared by causing a reaction between p-anilinophenol or napthylaminophenol and an acyloxy functional polyorganosiloxane, or by causing a reaction between p-anilinophenol or napthylaminophenol and a polyorganosiloxane having a silicon-bonded chlorine atom in the presence of hydrogen chloride sorbent.

Component (C) is used an amount of 0.001 to 10 parts by weight, preferably 0.005 to 8 parts by weight, and even more preferably 0.01 to 5 parts by weight, for each 100 parts by weight of component (A). If the amount of component (C) is less than the preferred lower limit, it can lead to a decrease in repeelability of the adhesive tape after exposure to high temperatures. On the other hand, if the amount of component (C) exceeds the preferred upper limit, it can impair the curability of the obtained pressure-sensitive adhesive, and can lead to a decrease in the adhesive strength and tackiness of the adhesive.

Component (D) is a platinum based catalyst that is used in the composition for promoting a crosslinking reaction. Component (D) is represented by chloroplatinic acid, an alcohol solution of chloroplatinic acid, platinum-carbonyl complexes, platinum-alkenylsiloxane complexes, and platinum-olefin complexes. The platinum-alkenylsiloxane complex is preferred since it possesses better compatibility with component (A). Some representative platinum-alkenylsiloxane complexes are 1,3-divinyltetramethyldisiloxane and 1,1,3,3-tetravinyldimethyldisiloxane.

Component (D) is used in an amount sufficient for promoting curing of the adhesive. Preferably, it should be used in such an amount that in terms of weight units, the metallic platinum contained in component (D) is within the range of 0.1 to 1,000 ppm, and more preferably 1 to 500 ppm based on the total weight of component (A). If component (D) is used in an amount less than the preferred lower limit, it will noticeably delay curing of the resulting pressure-sensitive adhesive. If, on the other hand, the added amount of component (D) exceeds the preferred upper limit, this can cause coloration of the resulting pressure-sensitive adhesive.

In addition to components (A) through (D), the adhesive of the invention may contain optional components for adjusting the speed of curing, such as alkyne alcohols including 2-methyl-3-butyn-2-ol, 3,5-dimethyl-1-hexyn-3-ol, 3-methyl-1-pentyn-3-ol, and 2-phenyl-3-butyn-2-ol; enyne compounds such as 3-methyl-3-penten-1-yne, and 3,5-dimethyl-3-hexen-1-yne; and alkenylsiloxanes such as 1,3,5,7-tetramethyl-1,3,5,7-tetravinylcyclotetrasiloxane, and 1,3,5,7-tetramethyl-1,3,5,7-tetrahexenylcyclotetrasiloxane.

The curing reaction adjuster should be added in an amount that is most efficient for adjusting the curing speed. Typically, it is used in an amount not exceeding 5 parts by weight for each 100 parts by weight of component (A). If it is used in an amount greater than 5 parts by weight for 100 parts by weight of component (A), the curing speed of the resulting pressure-sensitive adhesive will be significantly delayed.

The adhesive of the invention can be combined with organic solvents such as toluene, xylene, hexene, heptene, acetone, methylethylketone, and methylisobutylketone; alkoxysilanes such as tetramethoxysilane, tetraethoxysilane, dimethyldimethoxysilane, methylphenyldimethoxysilane, methylphenyldiethoxysilane, phenyltrimethoxysilane, methyltrimethoxysilane, methyltriethoxysilane, vinyltriethoxysilane, allyltrimethoxysilane, allyltriethoxysilane, 3-glycidoxypropyltrimethoxysilane, and 3-methacryloxypropyl-trimethoxysilane; as well as various antioxidants, pigments, and stabilizers.

The silicone-based pressure-sensitive adhesive of the invention is prepared by mixing components (A) through (D), and if necessary, with one or more appropriate optional components. The thusly prepared silicon-based pressure-sensitive adhesive is then applied to a substrate and cured at room temperature or with heating, to form a pressure-sensitive adhesive layer on the surface of the substrate. Coating can be carried out using a gravure coater, offset coater, offset gravure coater, roller coater, reverse roller coater, air knife coater, or a curtain coater.

The adhesive tape of the present invention contains a support film and a pressure-sensitive adhesive layer that is formed by curing the silicone-based pressure-sensitive adhesive of the present invention. Some suitable support films include stretched or non-stretched plastic films formed from resins such as polyimide, polyethylene, polypropylene, polystyrene, polyvinylchloride, polycarbonate, polyethylene terephthalate, and Nylons®. The support film can also consist of a plastic base coated with such resins. When heat resistant properties are desired, it is preferred to use resins such as polyimide, polyether-ether ketone (PEEK), polyethylene-naphthalate (PEN), liquid crystal arylate, polyamidoimide (PAI), or polyethersulfone (PES).

The adhesive tape is produced by applying the silicone-based pressure-sensitive adhesive to a support film, and then curing the applied adhesive at room temperature or with heating, to form the pressure-sensitive adhesive layer on the surface of the support film. The adhesive can be applied by one of the above mentioned methods. When the silicone-based pressure-sensitive adhesive is cured on the support film with heating, it is preferred to heat the adhesive to a temperature above 50° C., preferably to a temperature within the range of 80 to 200° C.

### EXAMPLES

The silicone-based pressure-sensitive adhesive and adhesive tape of the invention are set forth in more detail in the following Practical Examples and Comparative Examples. In the examples, the viscosity values were measured at 25° C., and the plasticity of the crude rubber was measured in accordance with Japanese Industrial Standards (JIS) K 6249, conducted at 25° C. with application of a 1 kg force for 3 minutes to a 4.2 gram spherical sample. The adhesive strength and repeelability after exposure to high temperature were determined by the methods described below.

Adhesive Strength

The silicone-based pressure-sensitive adhesive is applied to a support film of a polyimide resin in such an amount that, after curing, the pressure-sensitive adhesive layer that is formed has a thickness of about 40 μm. The adhesive sheet is formed by heating the resulting article for 3 minutes at 120° C. The adhesive sheet is cut into 25 mm wide strips to produce adhesive tapes. Using a rubber roller, the adhesive tapes are pressure bonded with a 2 kg force to the surface of a stainless steel plate polished with No. 360 water proof abrasive paper. The laminated product is retained intact for 30 minutes at room temperature, and then the adhesive force is measured with a tensile tester at a constant pulling rate of 300 mm/minute and a peeling angle of 180°.

Repeelability after Exposure to High Temperature

The silicone-based pressure-sensitive adhesive is applied to a support film of a polyimide resin in such an amount that, after curing, a pressure-sensitive adhesive layer is formed having a thickness of about 40 μm. The adhesive sheet is formed by heating the resulting article for 3 minutes at 120° C. The adhesive sheet is cut into 25 mm wide strips to produce adhesive tapes. Using a rubber roller, the adhesive tapes are pressure bonded with a 2 kg force to the surface of a stainless steel plate polished with No. 360 waterproof abrasive paper. The resulting laminated article is subjected to a 2 hours ageing period in an oven at a temperature that can be adjusted within the range of 200° C. to 300° C. in 10° C. increments. The article is then removed from the oven, maintained for 30 minutes at room temperature, and the tape is subjected to a peeling test on a tensile tester with a constant pulling speed of 300 mm/min. The surface of the stainless steel plate is then visually observed for the presence of residuals of adhesive deposits.

The results of these observations were evaluated using the following criteria: (i) repeelability was considered good and is shown in Tables 1 to 3 by the symbol “0” if repeeling did not leave any adhesive deposits; and (ii) repeelability was considered unsatisfactory and is shown in Tables 1 to 3 by the symbol “X” if repealing left adhesive deposits on the surface of the stainless steel plate.

### Practical Example 1

A mixture was prepared from (i) 25.6 parts by weight of a crude rubber-like copolymer of methylvinylsiloxane and dimethylsiloxane having vinyl groups on both molecular terminals and on a part of the side chains, having a plasticity of 135, and a content of vinyl groups of 0.2 weight percent; (ii) 54.6 parts by weight of a 60 weight percent xylene diluted solution of a methylpolysiloxane resin consisting of (CH₃)₃ SiO_{1/2} units and SiO_{4/2} units, with a 0.8 mole ratio of (CH₃)₃ SiO_{1/2} units to SiO_{1/2} units; (iii) 0.2 parts by weight of a methylhydrogenpolysiloxane capped at both molecular terminals with trimeihylsiloxy groups, having a viscosity of 20 mPa·s, and with a content of silicon-bonded hydrogen atoms of 1.55 weight percent; (iv) 0.2 parts by weight of 2-methyl-3-butyn-2-ol; (v) 0.2 parts by weight of a dimethylsiloxane containing p-anilinophenoxy groups, which is shown the formula: 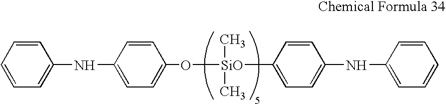
and (vi) 69.2 parts by weight of toluene. The resulting mixture was combined with a platinum-1,3-divinyl-1,1,3,3-tetramethyldisiloxane complex, where in terms of weight units, the metallic platinum consisted of 100 ppm based on the total weight of the crude rubber-like copolymer of methylvinylsiloxane and dimethylsiloxane and the methylpolysiloxane resin. As a result, a silicone-based pressure-sensitive adhesive containing 40 weight percent of the organopolysiloxane component was produced. The resulting pressure-sensitive adhesive was used for manufacturing an adhesive tape. The adhesive tape demonstrated good results of testing its adhesive strength and repeelability. The results of the tests are shown in Table 1.

### Comparative Example 1

In this example, a silicone-based pressure-sensitive adhesive was obtained by the same method used in Practical Example 1, except that 0.2 parts by weight of toluene was used instead of 0.2 parts by weight of the dimethylsiloxane containing a p-anilinophenoxy group. The resulting silicone-based pressure-sensitive adhesive was used for manufacturing an adhesive tape. The resulting adhesive tape was evaluated for its adhesive strength and repeelability. The results of this evaluation are shown in Table 1.

TABLE 1

| | Practical Example 1 | Comparative. Ex. 1 |
|---|---|---|
| Adhesive Strength (N/m) | 245 | 270 |
| Repeelability, Degrees | Results of Observations of Repeelability | |
| 200° C. | ◯ | ◯ |
| 210° C. | ◯ | ◯ |
| 220° C. | ◯ | ◯ |
| 230° C. | ◯ | ◯ |
| 240° C. | ◯ | ◯ |
| 250° C. | ◯ | ◯ |
| 260° C. | ◯ | X |
| 270° C. | ◯ | X |
| 280° C. | ◯ | X |
| 290° C. | X | X |

### Practical Example 2

A mixture was prepared from (i) 25.6 parts by weight of a crude rubber-like dimethylpolysiloxane having vinyl groups on both molecular terminals; (ii) 54.6 parts by weight of a 60 weight percent xylene diluted solution of a methylpolysiloxane resin consisting of (CH₃)₃ SiO_{1/2} units and SiO_{4/2} units having a 0.8 mole ratio of (CH₃)₃ SiO_{1/2} units to SiO_{1/2} units; (iii) 0.2 parts by weight of a methylhydrogenpolysiloxane capped at both molecular terminals with trimethylsiloxy groups, having a viscosity of 20 mPa·s, and a content of silicon-bonded hydrogen atoms of 1.55 weight percent; (iv) 0.2 parts by weight of 2-methyl-3-butyn-2-ol; (v) 0.2 parts by weight of a dimethylsiloxane containing p-anilinophenoxy groups shown in the formula: 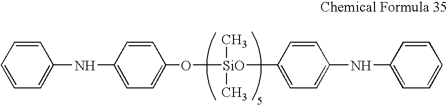
and (vi) 69.2 parts by weight of toluene. The resulting mixture was combined with a platinum-1,3-divinyl-1,1,3,3-tetramethyldisiloxane complex, where in terms of weight units, the metallic platinum consisted of 100 ppm based on the total weight the crude rubber-like dimethylpolysiloxane and the methylpolysiloxane resin. As a result, a silicone-based pressure-sensitive adhesive containing 40 weight percent of the organopolysiloxane component was produced. The resulting pressure-sensitive adhesive was used for manufacturing an adhesive tape. The resulting adhesive tape was evaluated for its adhesive strength and repeelability. Results of the evaluation are shown in Table 2.

### Comparative Example 2

In this example, a silicone-based pressure-sensitive adhesive was obtained by the same method as in Practical Example 2, with the exception that 0.2 parts by weight of toluene were used instead of 0.2 parts by weight of the dimethylsiloxane containing a p-anilinophenoxy group. The resulting silicone-based pressure-sensitive adhesive was used for manufacturing an adhesive tape. The resulting adhesive tape was evaluated for its adhesive strength and repeelability. Results of the evaluation are shown in Table 2.

TABLE 2

| | Practical Ex. 2 | Comparative Ex. 2 |
|---|---|---|
| Adhesive Strength (N/m) | 291 | 325 |
| Repeelability, Degrees | Results of Observations of Repeelability | |
| 200° C. | ◯ | ◯ |
| 210° C. | ◯ | ◯ |
| 220° C. | ◯ | ◯ |
| 230° C. | ◯ | X |
| 230° C. | ◯ | X |
| 250° C. | ◯ | X |
| 260° C. | X | X |

### Practical Example 3

A mixture was prepared from (i) 25.6 parts by weight of a crude rubber-like copolymer of methylvinylsiloxane and dimethylsiloxane having vinyl groups on both molecular terminals and on a part of side chains, having a plasticity of 135, and a content of vinyl groups of 0.07 weight percent; (ii) 54.6 parts by weight of a 60 weight percent xylene diluted solution of a methylpolysiloxane resin consisting of (CH₃)₃ SiO_{1/2} units and SiO_{4/2} units, having a 0.8 mole ratio of (CH₃)₃ SiO_{1/2} units to SiO_{1/2} units; (iii) 0.2 parts by weight of a methylhydrogenpolysiloxane capped at both molecular terminals with trimethylsiloxy groups, having a viscosity of 20 mPa·s, and a content of silicon-bonded hydrogen atoms of 1.55 weight percent; (iv) 0.2 parts by weight of 2-methyl-3-butyn-2-ol, and (v) 0.6 parts by weight of a mixture of aromatic amines represented by the average formula: 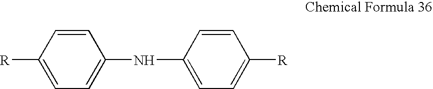
wherein R is a mixture of H and tert-C₈H₁₇.

The resulting mixture was combined with a platinum 1,3-divinyl-1,1,3,3-tetramethyldisiloxane complex, where in terms of weight units, the metallic platinum was 100 ppm based on the total weight of the crude rubber-like copolymer of methylvinylsiloxane and dimethylsiloxane and the methylpolysiloxane resin. As a result, a silicone-based pressure-sensitive adhesive was produced containing 40 weight percent of the organopolysiloxane component. The resulting pressure-sensitive adhesive was used for manufacturing an adhesive tape. The resulting adhesive tape was evaluated with regard to its adhesive strength and repeelability. Results of the evaluation are shown in Table 3.

### Comparative Example 3

In this example, a silicone-based pressure-sensitive adhesive was obtained by the same method as in Practical Example 3, with the exception that 0.6 parts by weight of toluene were used instead of 0.6 parts by weight of the mixture of aromatic amines. The resulting silicone-based pressure-sensitive adhesive was used for manufacturing an adhesive tape. The resulting adhesive tape was evaluated with regard to its adhesive strength and repeelability. Results of the evaluation are shown in Table 3.

### Practical Example 4

A mixture was prepared from (i) 25.6 parts by weight of a crude rubber-like copolymer of methylvinylsiloxane and dimethylsiloxane having vinyl groups on both molecular terminals and on a part of side chains, a plasticity of 135, and a content of vinyl groups of 0.07 weight percent; (ii) 54.6 parts by weight of a 60 weight percent xylene diluted solution of a methylpolysiloxane resin consisting of (CH₃)₃ SiO_{1/2} units and SiO_{4/2} units, having a 0.8 mole ratio of (CH₃)₃ SiO_{1/2} units to SiO_{1/2} units; (iii) 0.2 parts by weight of a methylhydrogenpolysiloxane capped at both molecular terminals with trimethylsiloxy groups, having a viscosity of 20 mPa·s, and a content of silicon-bonded hydrogen atoms of 1.55 weight percent; (iv) 0.2 parts by weight of 2-methyl-3-butyn-2-ol; (v) 0.3 parts by weight of a dimethylsiloxane containing p-anilino phenoxy groups shown in the formula: 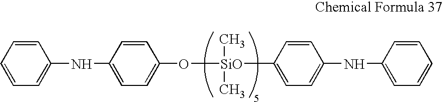
(vi) 0.3 parts by weight of a mixture of aromatic amines of the average formula:

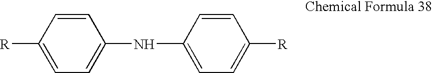

wherein R is a mixture of H and tert-C₈H₁₇; and (vii) 68.8 pats by weight of toluene. The resulting mixture was combined with a platinum 1,3-divinyl-1,1,3,3-tetramethyldisiloxane complex, where in terms of weight units, the metallic platinum consisted of 100 ppm based on the total weight of the crude rubber-like copolymer of methylvinylsiloxane and dimethylsiloxane and the methylpolysiloxane resin. As a result, a silicone-based pressure-sensitive adhesive containing 40 weight percent of the organopolysiloxane component was produced. The resulting pressure-sensitive adhesive was used for manufacturing an adhesive tape. The resulting adhesive tape was evaluated with regard to its adhesive strength and repeelability. Results of the evaluation are shown in Table 3.

TABLE 3

| | Pr. Ex. 3 | Pr. Ex. 4 | Comp. Ex. 3 |
|---|---|---|---|
| Adhesive Strength (N/m) | 226 | 257 | 245 |
| Repeelability, Degrees | Results of Observations of Repeelability | | |
| 200° C. | ◯ | ◯ | ◯ |
| 210° C. | ◯ | ◯ | ◯ |
| 220° C. | ◯ | ◯ | ◯ |
| 230° C. | ◯ | ◯ | ◯ |
| 240° C. | ◯ | ◯ | ◯ |
| 250° C. | ◯ | ◯ | X |
| 260° C. | ◯ | ◯ | X |
| 270° C. | ◯ | ◯ | X |
| 280° C. | ◯ | ◯ | X |
| 290° C. | X | X | X |

The evaluation of repeelability after exposure to high temperatures showed that, in the case of Practical Examples 1 and 2, use of component (C) in the form of an organopolysiloxane with aromatic amino groups, left noticeable traces on the surface of the stainless steel plate after peeling of the adhesive sheet from the plate. This color change was believed to be caused by the presence of the organopolysiloxane with aromatic amino groups that is subject to color change. In contrast, in Practical Example 4, the use of component (C) in the form of a combination of an aromatic amine compound with the organopolysiloxane with aromatic amino groups, limited the variation in color and left practically no traces on the surface of the stainless steel plate after peeling the adhesive sheet from the plate.

The adhesive tape of the invention possesses good repeelability after exposure to high temperatures and may be used as a heat treatment masking tape in solder reflow processes used in the manufacture of printed circuit boards.

1. A silicone-based pressure-sensitive adhesive comprising:
(A) a product of partial condensation of constituents (a) and (b) or a mixture of constituents (a) and (b), where constituent (a) is a crude rubber-like organopolysiloxane having an average of at least one alkenyl group per molecule, and constituent (b) is an organopolysiloxane resin consisting essentially of R¹₃SiO_{1/2} units where R¹ is a substituted or unsubstituted univalent hydrocarbon group, and SiO_{4/2} units, and where the mole ratio of R¹₃SiO_{1/2} units to SiO_{4/2} is in the range of 0.5 to 1.5;
(B) an organopolysiloxane having an average of at least two silicon-bonded hydrogen atoms per molecule, where the silicon-bonded hydrogen atoms are present in an amount of 0.5 to 150.0 moles per one mole of alkenyl groups in component (A);
(C) an aromatic amine compound and/or an organopolysiloxane containing aromatic amino groups, in an amount of 0.001 to 10 parts by weight for each 100 parts by weight of component (A); and
(D) a platinum catalyst in an amount sufficient to cure the adhesion.

2. A silicone-based pressure-sensitive adhesive according to claim 1 in which the aromatic amine compound of component (C) has a general formula: 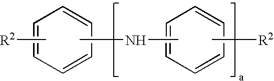
where each R² group is H, OH, or a univalent hydrocarbon group; and a is an integer equal to at least one.

3. A silicone-based pressure-sensitive adhesive according to claim 1 in which the organopolysiloxane of component (C) has a general formula: 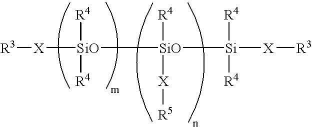
where R³ is a substituted or unsubstituted univalent hydrocarbon group or an aromatic amino group; R⁴ is a substituted or unsubstituted univalent hydrocarbon group; R⁵ is an aromatic amino group; X is a single bond, an oxygen atom, an alkylene group, or an alkyleneoxy group; m is a positive number, n is zero or a positive number; provided that when n is zero, at least one of the R³ groups is an aromatic amino group.

4. A silicone-based pressure-sensitive adhesive according to claim 1 in which further comprising at least one curing reaction ajuster.

5. A silicone-based pressure-sensitive adhesive according to claim 1 in which further comprising at least one solvent for components (A) through (D).

6. An adhesive tape comprising a support film and a pressure-sensitive adhesive layer in which the adhesive layer is formed by curing a silicone-based pressure-sensitive adhesive according to claim 1.
